(19) United States
(12) Patent Application Publication
(10) Pub. No.: US 2017/0178041 A1
(43) Pub. Date: Jun. 22, 2017

(54) COMPLETION CONTRACTS

(71) Applicant: Hewlett Packard Enterprise Development LP, Houston, TX (US)

(72) Inventors: Andrew Li, Palo Alto, CA (US); Julie Ward Drew, Redwood City, CA (US); Filippo Balestrieri, Mountain View, CA (US); Bernardo Huberman, Palo Alto, CA (US)

(21) Appl. No.: 14/975,006

(22) Filed: Dec. 18, 2015

(51) Int. Cl. G06Q 10/06; H04L 29/08

(52) U.S. Cl. CPC G06Q 10/06313; H04L 67/10

(57) ABSTRACT

Examples of providing completion contracts are included. Completion contracts are offered for a request for cloud services. The completion contracts are continuous-decision based and have different prices and different durations to complete the request for cloud services.

### BACKGROUND

The Cloud refers to hardware and software resources available across the Internet. Companies that offer cloud resources are referred to as Cloud Service Providers (CSP). Cloud services can be roughly categorized as Infrastructure-as-a-Service (IaaS), Platform-as-a-Service (PaaS) and Software-as-a-Service (SaaS). This categorization is based on the complexity of the service, from raw compute resources, such as storage or processing power, to refined software services, such as databases or other applications.

### BRIEF DESCRIPTION OF THE DRAWINGS

FIG. 1 illustrates an example system to provide a completion contract according to the present disclosure.

FIG. 2 illustrates a diagram of an example computing device according to the present disclosure.

FIG. 3 illustrates a diagram of an example system for pricing of cloud resources according to the present disclosure.

FIG. 4 illustrates an example cloud service menu according to the present disclosure.

FIG. 5 illustrates an example flow chart of a method for providing a completion contract according to the present disclosure.

### DETAILED DESCRIPTION

A cloud service provider can offer resources that may be utilized by customers to perform computing tasks. The cloud service provider can price and schedule so that the computing tasks are performed to the satisfaction of the customer.

Completion contracts in accordance with the present disclosure can be offered by a cloud service provider to a customer. The completion contracts can be generated such that revenue to the cloud service provider may be increased, while resources are allocated for fulfillment of the completion contracts.

A cloud service provider may own and/or manage many nodes (e.g., thousands or even hundreds of thousands). Exact optimal prices for cloud services jobs may be determined via a discrete decision (e.g., integer programming). While it may be possible to solve for exact optimal prices to for cloud services jobs, a state space utilized to solve for the exact optimal prices must encode the ongoing capacity of the cloud resource system; as such, the state space grows quickly with the number of nodes. This growth makes the exact optimal price solution computationally unfeasible, even with several hundred nodes.

However, the completion contracts described herein may be priced utilizing “fluid” demand and capacity (e.g., different prices of different completion contracts are determined via fractional nodes, rather than discrete (integer) nodes used for the exact optimal price solution). The completion contracts, as discussed herein, may be priced via a continuous decision (e.g., linear programming). Discrete nodes are represented by integers (e.g., 0 and 1), whereas fractional nodes may be represented by any numerical values between two integers, for example, 0 and 5 (e.g., 0, 1, 2.5, 4.1, etc.).

As such, the pricing problem of the completion contracts described herein does not grow as the number of nodes of the cloud resource system grows. Additionally, the pricing problem of the completion contracts described herein is quickly solvable with reduced computational resources, as compared to the exact optimal prices for cloud services jobs.

Further, scheduling (e.g., to provide completion of an accepted completion contract within a particular duration) and pricing (e.g., maximizing profit of a cloud service provider) of the completion contracts described herein may be solved jointly. For instance, as discussed herein, the scheduling and pricing of the completion contracts are combined by translating the scheduling problem into the constraints included in the pricing problem. Thereafter, accepted completion contracts are executed by duration to complete.

Because lessor cloud resources are available, the completion contracts described herein can be generated via an estimated (e.g., extrapolated) benchmark completion duration. Utilizing the estimated benchmark completion duration provides that completion contracts having an uncertain job size can be guaranteed to be completed within an accepted duration to complete. In contrast, other guarantees to complete a job may require either a perfect benchmark of the job size or an overly conservative assumption of the job size, which may reduce cloud service provider revenue.

Additionally, examples of the present disclosure may be unaffected by customer “gaming”. For instance, there may be a concern as to whether a customer may benefit from a misrepresentation of the customer's interests. For example, a customer may misrepresent a preference for a deadline to complete a job or misrepresent job size. However, the completion contracts described herein are priced “per-node”, which renders these misrepresentations of no benefit to the customer.

The cloud computing model allows users (e.g., customers) to rent computing infrastructure as desired, rather than having to purchase their own resources, for instance. The customer may rent the cloud services needed to complete a particular job. The particular jobs can be executed within a virtualized environment (e.g., a “cloud”). Other technologies, aside from hardware virtualization, may be utilized (e.g., data compute nodes). Data compute nodes may include non-virtualized physical hosts, virtual machines (VMs), containers that run on top of a host operating system without a hypervisor or separate operating system, and/or hypervisor kernel network interface modules, among others.

Computing tasks, such as a batch application, may herein be referred to as a “service” a “job”, or a “cloud service”, and may include the usage of resources such as virtual servers or nodes. A cloud service may be a deployable unit comprised of one or more job steps. An example of a cloud service may be a Monte Carlo simulation. Another example of a cloud service may be an optimization problem. Another example is a data mining job. Put another way, a cloud service may be a single well defined job that includes a plurality of processes to be completed. A cloud service may include a series of closely related processing steps that, taken together, perform a particular process and/or processes.

Cloud services may be sold according to a resource-based model in which the customer rents the resources (nodes or instances per unit time) from a cloud service provider. Cloud services may be sold according to various resource-based selling models: on-demand instances, reserved instances, and spot instances. On-demand instances allow users to rent nodes (when nodes are available) at a fixed hourly rate without any long term commitment. Some providers offer an additional feature with on-demand instances, where users can set a maximum budget on their cloud expenses, thus enabling the users to control costs. Reserved instances are nodes that are also rented at a fixed rate per unit time but may include a long-term commitment (e.g., one or more years) and upfront payment from the user. In exchange for this long term commitment the user may receive a lower hourly rate and a guarantee (subject to service level agreements) that the nodes will be available when needed. Further, some providers maintain a market through which users can resell their unused reserved instances.

Some providers also offer a resource-based selling model, referred to as spot instances, with dynamic spot prices expressed in dollars per hour. In this market, users may bid for spot instances by providing a maximum price they are willing to pay per instance per hour. The instances supplied are the ones that have not been sold as on-demand or reserved instances. At each point of time the spot price is the price at which the market clears (e.g., demand matches supply). If a user's maximum price bid exceeds the current spot price, his request is fulfilled and his instances will run until either he chooses to terminate them or the spot price increases above his maximum price (whichever happens sooner).

Examples of the present disclosure may be per-resource-period priced (e.g., that depends on a time in which a request for nodes is submitted and on the duration in which the request is completed). A customer may determine whether to accept a completion contract that is offered given his willingness to pay a particular price of that completion contract. In some examples, a service provider may receive service requests over time (e.g., continuously, dynamically), and can maximize a profit by assigning resource prices in each time period to requests arriving in that period. Examples of the present disclosure may include systems, methods, and machine-readable and executable instructions and/or logic.

Pricing of cloud resources according to the present disclosure allows a practical implementation of resource-based sale of cloud services. While the foregoing disclosure generally refers to a “customer” and a “user” interchangeably, it is noted that a “customer” may be either an internal customer or an external customer. Put another way, the cloud services may be offered to users within the same company and/or organization as the cloud service provider. For instance, examples of the present disclosure may be applied to distribute private cloud resources across different departments within an enterprise (e.g., organization).

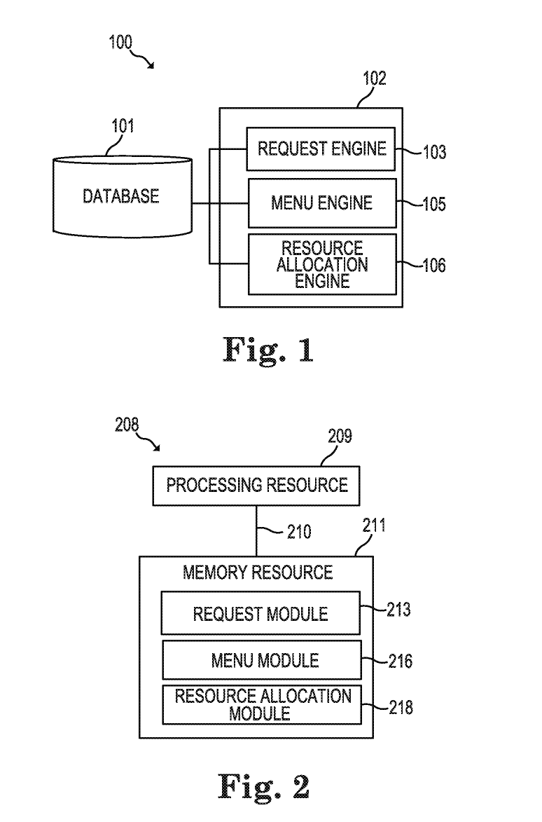

FIG. 1 illustrates an example system 100. The system 100 can provide a cloud service menu including a number of completion contracts for a request for cloud services according to the present disclosure. The system 100 may include a database 101, a subsystem 102, and/or a number of engines (e.g., request engine 103, a menu engine 105, and a resource allocation engine 106). As used herein, “a” or “a number of” something can refer to one or more such things. For example, “a number of completion contracts” can refer to one or more completion contracts. The subsystem may include the number of engines in communication with the database 101 via a communication link. The system 100 may include additional or fewer engines than illustrated to perform the various functions described herein. The system may represent software and/or hardware of a network controller (e.g., device 208 as referenced in FIG. 2, etc.).

The number of engines may include a combination of hardware and programming that is configured to perform a number of functions described herein (e.g., receive a request for a cloud service from a user of a cloud system, etc.). The programming may include program instructions (e.g., software, firmware, etc.) stored in a memory resource (e.g., computer readable medium (CRM), machine readable medium (MRM), etc.) as well as hard-wired program (e.g., logic).

The request engine 103 may include a combination of hardware and programming that is configured to be capable of continuously receiving requests (e.g., online) from a plurality of users (e.g., customers) of a cloud system. As used herein, a cloud service request refers a request by a customer to perform a computing task. The computing task may be performed by utilizing via resources such as virtual servers or nodes. The request engine 103 may continuously receive requests for cloud services from a plurality of users of a cloud system, for instance.

Examples of the present disclosure provide that a cloud service request may be received while other jobs are running/executing on the cloud service (e.g., the cloud service request may be received online). For instance, requests from customers may be received by the cloud service provider at any time (e.g., continuously, sequentially). Put another way, the requests may be received dynamically. As used herein, continuously receiving requests refers to receiving requests by the cloud service provider while the cloud service provider is using resources. At each point in time, the cloud service provider may receive different requests to execute jobs. As used herein, dynamically receiving requests refers to the cloud service receiving requests in a usually continuous, productive, or changing manner. In such instances, certain nodes in the cloud service may be in use, meaning an incoming request may not be fulfilled using that occupied node.

In some examples, the system 100 may include an input engine (not illustrated in FIG. 1) that may include a combination of hardware and programming that is to receive parameters, as discussed herein. The parameter can relate to a requested cloud service from at least one user and a cloud service provider. Examples of the present disclosure provide that a user (e.g., customer) may provide parameters, the cloud service provider may provide parameters, or both the user and cloud service provider may provide parameters. As used herein, a parameter refers to an input that has a known value. As used herein, known values can include estimated values. The input engine may receive a number of parameters, as discussed herein.

In some examples, the system 100 may include a benchmark engine (not illustrated in FIG. 1) that may include a combination of hardware and programming that is to generate a benchmark completion duration for a request for cloud services. The benchmark completion duration can be utilized as a determination of a size of job (e.g., a size of a request for cloud services). The benchmark engine may utilize a number of benchmark nodes (i.e., nodes reserved for the benchmark engine). A request for cloud services can be run on benchmark node for a predetermined time that is less than completion duration for the particular job. A percentage of the job that is completed in the predetermined time may be extrapolated to provide the benchmark completion duration. For instance, a requested job may be run on a single node for one minute to complete 2% of the job. The benchmark completion duration may then be determined as 50 minutes (1 minute*(100%/2%)). However, some examples of the present disclosure provide that the benchmark completion duration may be equal to the actual completion duration.

The menu engine 105 may include a combination of hardware and programming that is configured to generate (e.g., provide) a cloud service menu to be offered to a number of users. The menu engine 105 may provide a cloud menu including a number completion contracts for a request for cloud services.

Rather than selling node-periods directly, examples of the present disclosure provide that a cloud service provider can offer completion contracts. The completion contracts can provide (e.g., guarantee) that a job will be completed within a specified duration.

A number of parameters may be utilized to provide the completion contracts. M can be defined as a number of nodes the cloud service provider is managing. Time can be considered a sequence of discrete intervals (e.g. minutes, hours, days, etc.). Given that, a set of time periods T={1, . . . , 7} may be considered. In each period, requests for cloud services (e.g., requests for nodes) may be submitted by a customer and received by the cloud service provider. T can be defined as a number of periods considered for the completion contracts. D can be defined as the maximum duration offered for the completion contracts. A demand function: lₜ^{d}(pₜ¹, . . . , pₜ^{D}) can be defined as an expected number of nodes that will be requested at period t for duration d, given that a price list is set to: pipe, pₜ¹, . . . , pₜ^{D}. Available commitments can be defined such that for any two periods 1≦a<b≦T, it is denoted that the set of period-duration pairs whose execution must fall within the interval from a to b as l(a,b), and the number of contracts we can feasibly accept for period-duration pairs in l(a,b) is denoted x_{a,b}. For example, x_{a,b} is initially set to (b−a)M.

A number of variables may be utilized to provide the completion contracts. Some examples of the present disclosure provide that two variables are utilized. For instance, a first variable may be per-node-period prices pₜ^{d} at each period t=1, . . . , T and for each duration d=1, . . . , D, and a second variable may be an expected number of outsourced node-periods sₜ^{d} at each period t=1, . . . , T and for each duration d=1, . . . , D. Examples of the present disclosure provide, in contrast to other approaches, that the number of variables utilized does not increase as a number of requests increases. In other words, other approaches utilized variables that are associated with particular requests.

Utilizing parameters and variables described herein, a cloud service provider's expected revenue at period t for completion contracts of duration d can be defined as pₜ^{d} lₜ^{d}(pₜ¹, . . . , pₜ^{D}). An expected outsourcing cost for a same cloud services offering can be defined as csₜ^{d}, where c is a price to acquire a lessor cloud resource (e.g., rent an outsourced node-period)

As such, expected profit can be maximized by

ΣₜΣ_{d}pₜ^{d} lₜ^{d}(pₜ¹, . . . , pₜ^{D})−c sₜ^{d}

subject to:

Σ_{(t,d)∈l(a,b)}lₜ^{d}(pₜ¹, . . . , pₜ^{D})−sₜ^{d}≦x_{1,b} for all 1≦a<b≦T
pₜ^{d}≧0 for all t=1, . . . , T and d=1, . . . , D
sₜ^{d}≧0 for all t=1, . . . , T and d=1, . . . , D.
   For each interval of period [a,b], there is a constraint ensuring that the expected demand for nodes within that period, less outsourcing, does not exceed the current capacity within that interval. Also, per-node-period prices and outsourcing are restricted to be non-negative. The expected demand, as discussed herein, is associated with a given price (e.g., a particular price). In contrast, other approaches have utilized implicit modeling of each possible demand realization.

It can be defined that a cloud service provider offers durations of at most 0. At a beginning of each period t, a list of per-node-period prices (pₜ¹, . . . , pₜ^{D}) may be utilized, where pₜ^{d} can be defined as a price of a single node-period to be allocated within a duration of d periods. As such, pₜ^{d} can be a menu price, at duration d, for a job having a size of one node. Then, throughout period t, a price offered for other jobs, submitted at duration d, will equal a product of the submitted job's size and pₜ^{d}. For instance, for a particular period, an additional completion contract corresponding to a job submitted at a particular duration has an offered price equal to a product of the job size and a per-node-price allocated for the particular duration.

A cloud service provider may not offer completion contracts at duration d at period t; for such instances, pₜ^{d} may be set as infinitely high.

For each period t, given a cloud service provider's per-node-period prices (pₜ¹, . . . , pₜ^{D}), customer demand for node-periods of duration d can be calculated as a sum of the sizes of all jobs to be completed within duration d. This demand may be defined as a random quantity, Lₜ^{d}(pₜ¹, . . . , pₜ^{D}), whose expectation is defined as lₜ^{d}(pₜ¹, . . . , pₜ^{D}). This demand provides that a demand at each period depends only that period's prices (so it is independent over different periods), and a demand for a given duration depends on the prices of all durations at that period, as customers may choose between multiple durations.

Examples of the present disclosure provide that a cloud service provider may outsource cloud service resources. For instance, the cloud service provider (a first organization) may own and/or manage a number of cloud service resources. The cloud service resources owned and/or managed by the first organization may be referred to as local cloud resources. The first organization may rent cloud services resources, such as nodes, from a second organization (e.g., a lessor). The lessor cloud resources may be indistinguishable, from a job completion viewpoint, from the local cloud resources. The cloud service provider may outsource (e.g., at any period the cloud service provider can rent lessor cloud resources), at a cost of c per node-period.

As such, when a completion contract is accepted by a customer (e.g., when a completion contract is sold) at a given menu price, the cloud service provider can receive that given menu price as revenue. The cloud service provider's total profit may be determined as a sum of all revenues minus an amount paid for outsourcing. Accordingly, the cloud service provider may dynamically set per-node-period prices at each period to increase (e.g., maximize) expected profits while ensuring each accepted completion contract is completed by a particular duration to complete.

Maximizing expected profit may be regarded as a nonlinear optimization that can be solved utilizing various solvers (e.g., continuous-decision solvers). Suitable open-source solvers include IPOPT and NLopt, among others. Suitable commercial solvers include KNITRO® and MOSEK®, among others.

Examples of the present disclosure provide that the demand function lₜ^{d}(pₜ¹, . . . , pₜ^{D}) can decompose into:

lₜ^{d}(pₜ¹, . . . , pₜ^{D})=[expected number of potential customers]·[expected job size]·qₜ^{d}(pₜ¹, . . . , pₜ^{D}),

where qₜ^{d}(pₜ¹, . . . , pₜ^{D}), which may be referred to as a choice function, is the expected proportion of customers that choose a completion contract of duration d when offered prices (pₜ¹, . . . , pₜ^{D}). The expected number of potential customers and the expected job size may be estimated (e.g., via averages of previous data). Modeling of the choice function may reflect that customers make rational decisions and are not willing to pay more for a later duration to complete requested cloud services.

As an example, the choice function may be modeled such that each customer has an underlying value U drawn from a distribution. Given that a customer's underlying value is U, then the customer's willingness to pay for completing a job with duration d is U/d multiplied by an estimated size of the job. Having a menu of prices, a customer will choose the duration to complete the job that maximizes the customer's utility, which may be defined as a willingness to pay less that price, or the customer will not choose any completion contract if no choice yields positive utility. Then, qₜ^{d}(pₜ¹, . . . , pₜ^{D}) is the probability that a customer's underlying value U is such that the utility maximizing choice is d:

qₜ^{d}(pₜ¹, . . . , pₜ^{D})=Pr(U/d−pₜ^{d}≧U/d′−pₜ^{d′} for all d′; U/d−pₜ^{d}≧0).

The variable U may be interpreted as a customer's willingness to pay for a single node-period delivered immediately. Because this product is offered in the Cloud market, U may be estimated from existing demand data.

For pricing and/or scheduling x_{a,b} may be initially set to (b−a)M. Then, at the beginning of each period t: x_{a,b} may be updated to reflect demand from the previous period; for the current period, nodes may be allocated to jobs having the shortest completion durations, where lessor nodes are acquirable to, if necessary, to complete jobs due to be completed in the period; perform the optimization as discussed herein to obtain an optimal solution p*; and set the cloud service menu price to pₜ*, while accepting incoming requests for cloud services unless capacity in any interval [a,b] is filled.

As mentioned, the menu engine 105 may generate a cloud service menu including a number of completion contracts for a request for cloud services. As discussed herein, the completion contracts are continuous-decision based and have different prices and different durations to complete the request for cloud services. As an example, the cloud service menu include a first completion contract having a first price and a first completion duration, and a second completion contract having a second price and a second completion duration, wherein the first price is greater than the second price and the first completion duration less than the second completion duration. Examples are not so limited, however, and the cloud service menu may include more or fewer completion contracts than described herein. A customer may select (e.g., accept) a completion contract from the cloud service menu to have a cloud service job completed.

In some examples, the system 100 may include an optimization engine (not illustrated in FIG. 1). The optimization engine may include a combination of hardware and programming that is configured to dynamically define (e.g., optimize) the price per-resource-period as new requests for cloud services are received. As used herein, dynamic optimization refers to adjusting offers of prices per-resource as new information is obtained and/or learned. For instance, as new customer and job information is received in a dynamic (e.g., continuous, productive, changing, etc.) manner, offers may change to better maximize profits and/or efficiency.

In some examples, the system 100 may include a selection engine (not illustrated in FIG. 1). The selection engine may include a combination of hardware and programming that is configured to receive and/or record a customer's selection of a particular completion contract. In some examples, the selection engine may determine that a user has declined the completion contracts in the cloud service menu after a threshold period of time has elapsed and a user selection has not been received, for instance.

The system 100 may include a resource allocation engine 106. The resource allocation engine 106 may include a combination of hardware and programming that is to allocate a number of cloud resources to complete the request for cloud services in response to a user selection of one of the number of completion contracts. In a number of examples, the resource allocation engine 106 may execute jobs (e.g., where sooner duration to complete jobs are executed prior to later duration to complete jobs) according to the accepted completion contracts.

FIG. 2 illustrates a diagram of an example computing device 208 according to the present disclosure. The computing device 208 may utilize software, hardware, firmware, and/or logic to perform a number of functions described herein. The computing device 208 may be any combination of hardware and program instructions configured to share information. The hardware, for example, may include a processing resource 209 and/or a memory resource 211 (e,g., CRM, MRM, database, etc.). A processing resource 209, as used herein, may include any number of processors capable of executing instructions stored by a memory resource 211. Processing resource 209 may be implemented in a single device or distributed across multiple devices. The program instructions (e.g., computer readable instructions (CRI)) may include instructions stored on the memory resource 211 and executable by the processing resource 209 to implement a desired function (e.g., receive requests for cloud services from a plurality of users of a cloud system). While FIG. 2 generally illustrates a single computing device 208, examples are not so limited. For instance, the system 100 (described in FIG. 1) may be implemented on a plurality of computing devices, such that each engine described in FIG. 1 and each module described in FIG. 2 may be executed by one or more computing devices.

The memory resource 211 may be in communication with a processing resource 209. A memory resource 211, as used herein, may include any number of memory components capable of storing instructions that may be executed by processing resource 209. Such memory resource 211 may be a non-transitory CRM or MRM. Memory resource 211 may be integrated in a single device or distributed across multiple devices. Further, memory resource 211 may be fully or partially integrated in the same device as processing resource 209 or it may be separate but accessible to that device and processing resource 209. Thus, it is noted that the computing device 208 may be implemented on a participant device, on a server device, on a collection of server devices, and/or a combination of the user device and the server device. As used herein, servers may also be referred to as “nodes”.

The memory resource 211 may be in communication with the processing resource 209 via a communication link (e.g., a path) 210. The communication link 210 may be local or remote to a machine (e.g., a computing device) associated with the processing resource 209. Examples of a local communication link 210 may include an electronic bus internal to a machine (e.g., a computing device) where the memory resource 211 is one of volatile, non-volatile, fixed, and/or removable storage medium in communication with the processing resource 209 via the electronic bus.

A number of modules (e.g., request module 213, menu module 216, and resource allocation module 218) may include CRI that when executed by the processing resource 209 may perform a number of functions. The number of modules may be sub-modules of other modules. For example, the request module, the output module, the menu module, and the resource allocation module can be sub-modules and/or contained within the same computing device. In another example, the number of modules can comprise individual modules at separate and distinct locations (e.g., CRM, etc.).

Each of the number of modules may include instructions that when executed by the processing resource 209 may function as a corresponding engine as described herein. For example, the request module 213 may include instructions that when executed by the processing resource 209 may function as the request engine 103.

The request module 213 may include instructions that when executed by the processing resource 209, may continuously receiving requests for cloud services from a plurality of users of a cloud system. As described in relation to FIG. 1, cloud service requests may come in continuously, and may be received from a single user of the cloud system or from a plurality of users of the cloud system.

In some examples, an input module (not illustrated in FIG. 2) may include instructions that when executed by the processing resource 209, may receive a number of parameters, as discussed herein. As previously noted, a parameter may be provided by the user, the cloud service provider, or both.

The computing device 208 may include a menu module 216 that when executed by the processing resource 209 may generate (e.g., provide) a cloud service menu to be offered to a number of users. The menu engine 105 may provide a cloud menu including a number completion contracts for a request for cloud service. The menu module 216 may include instructions that when executed by the processing resource 209 may provide a cloud service menu to the plurality of users for completion of the plurality of cloud service requests, the cloud service menu including a number completion contracts for a request for cloud services, wherein the completion contracts are continuous-decision based and have different prices and different durations to complete the request for cloud services For instance, four cloud service requests may be received and cloud menus may be provided for only three of the received cloud service requests. In another example, no cloud menus may be provided. For instance, three cloud service requests may be received but no cloud menus are provided to the users.

The computing device 208 may include a resource allocation module 218. The resource allocation module 218 may include instructions that when executed by the processing resource 209 allocate cloud resources to fulfill a user-selected completion contract from the cloud menu, wherein the allocated cloud resources are selected from local cloud resources and lessor cloud resources.

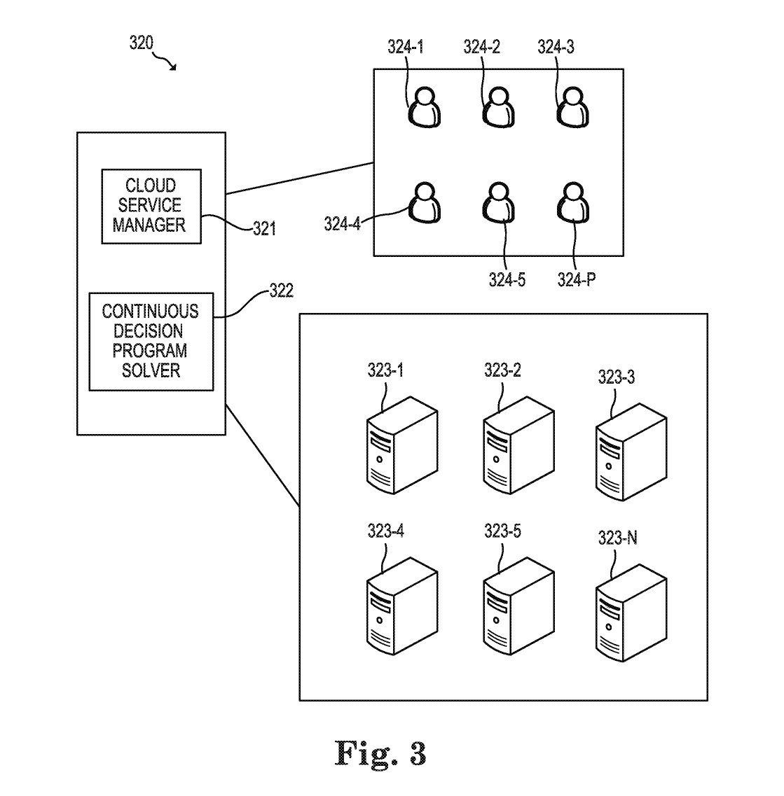

In some examples, the computing device 208 may further include instructions that when executed by the processing resource 209 configured to receive periodic use rates (e.g., rental rates) for lessor cloud resources, among other instructions. As discussed in relation to FIG. 3, the computing device 208 may include instructions to utilize constraints and/or variables, as discussed herein, to maximize the revenue received (by the cloud service provider) from the plurality of cloud service requests. Provided completion contracts, in some examples, may depend on a job request arrival time and a duration to complete the particular job request.

FIG. 3 illustrates a diagram of an example system 320 for providing completion contracts according to the present disclosure. As illustrated in FIG. 3, the system 320 may include a cloud service manager 321, a continuous-decision programming solver 322, and a plurality of cloud resources 323-1, . . . 323-N (collectively referred to as resources 323). As described herein, a cloud resource refers to a virtual or physical component in a cloud system. Examples of cloud resources 323 may include VMs, virtual servers, physical servers, and/or nodes among other resources. Some examples provide that cloud resources 323 may be exclusive, in that at each point of time, each resource 323 can be applied only to one service. Furthermore, cloud resources 323 may be re-usable in that past usage of a particular cloud resource 323 does not affect future usability of the cloud resource 323. Additionally, cloud resources 323 may be mobile in that a cloud resource 323 that was utilized for a first service at one point of time may be reallocated to a second service at a second (e.g., subsequent) point of time. Moreover, cloud resources 323 may be non-perishable in that they do not expire after a certain time.

The cloud service manager 321 may deploy and manage cloud services. For instance, the cloud service manager 321 may receive requests online for cloud services from a plurality of users 324-1, . . . , 324-P (e.g., customers) of a cloud system. Put another way, requests for cloud services may be collected continuously by the cloud service manager 321. Each service request may also be referred to as a “job”. Because of the continuous, online nature of the collection, a full set of jobs may not be known; rather sets of jobs develop dynamically. Each job served may have a number of resources (e.g., nodes) assigned in possibly multiple time periods until completion of the job. As discussed, lessor cloud resources may be utilized to complete a number of jobs. The cloud service manager 321 may determine, periodically for instance, a per-resource price for a lessor cloud resource (e.g., the cost of renting a lessor node).

The variables and constraints (e.g., rules), as discussed herein, may be utilized by the cloud service manager 321 to generate the cloud service menu and offer a number of completion contracts to a user. The completion contracts are continuous-decision based and have different prices and different durations to complete the request for cloud services.

Based on cloud service requests from the users 324, the cloud service manager 321 may determine a plurality of variables, as discussed herein. In some examples, a plurality of scenarios may be constructed in which an accepted completion contract may be completed. For each of those scenarios, a number of resources 323 may be selected to complete the accepted completion contract. However, as described herein, the cloud service manager may also decide delay assignment of resources 323 to a completion contract, for instance, in order to assign resources 323 to another completion contract having a nearer duration to complete.

A request may be considered as work or a job that needs to be completed, but in some examples, it may be a node-period reservation by the customer. The customer may use the node-periods for any purpose they choose, including leaving them idle for the duration of the request's “processing” time.

The cloud service manager 321 may allocate a set of cloud resources 323 to complete the request for cloud services in response to a completion contracts being accepting by a user 324. The allocated cloud resources 323 may be local cloud resources, lessor cloud resources, or a combination thereof. For examples where lessor cloud resources are utilized, the cloud service manager 321 may acquire the lessor cloud resources.

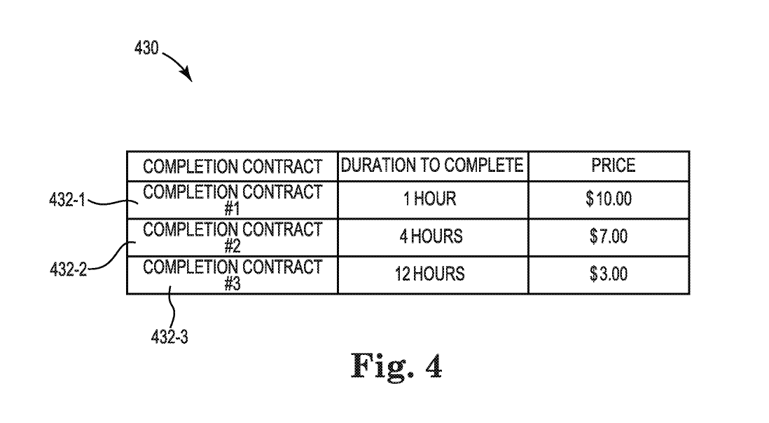

FIG. 4 illustrates an example cloud service menu 430 according to the present disclosure. The cloud service menu 430 menu can include a number of completion contracts 432-1, 432-2, 432-3. The completion contracts 432 are continuous-decision based and have different prices and have different durations to complete. While FIG. 4 illustrates three completion contracts 432, examples are not so limited. For instance, the cloud service menu 430 may include more than three completion contracts or fewer than three completion contracts.

As illustrated in FIG. 4, each of the completion contracts has a different duration to complete a particular job. Completion contract #1 432-1 has a duration to complete of one hour, completion contract 432-2 #2 has a duration to complete of four hours, and completion contract #3 432-3 has a duration to complete of 12 hours. As an example, if a user were to accept completion contract #2, an associated job request would be completed within four hours.

As illustrated in FIG. 4, each of the completion contracts has a different price to complete a particular job. Completion contract #1 432-1 has a price of ten dollars, completion contract 432-2 #2 has a price of seven dollars, and completion contract #3 432-3 has a price of three dollars. As an example, if a user were to accept completion contract #2, an associated job request would be completed at a cost of seven dollars to the user.

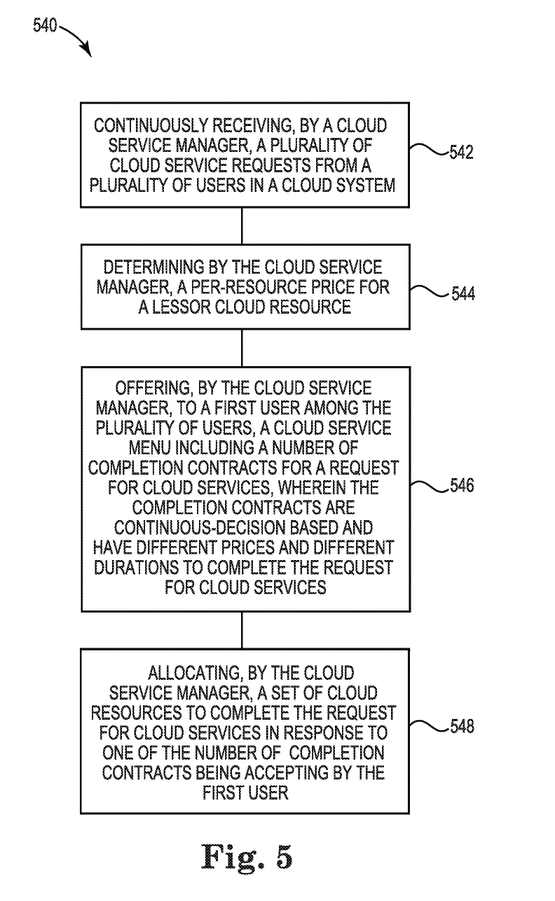

FIG. 5 illustrates an example flow chart of a method 540 for providing a completion contract according to the present disclosure. At 542, the method 540 can include continuously receiving, by a cloud service manager, a plurality of cloud service requests from a plurality of users in a cloud system. As discussed herein, users may submit cloud service requests. In some examples, the method 540 can include receiving a list of cloud service requests that the cloud service provider may consider. For example, each of the plurality of cloud service requests may be indexed, the indexing which may assist in the assignment of resources to complete each service request within particular durations to complete.

At 544, the method 540 can include determining by the cloud service manager, a per-resource price for a lessor cloud resource. As discussed herein, lessor cloud resources (e.g., lessor nodes) may be utilized to complete a number of accepted completion contracts. The per-resource price for a lessor cloud resource may be utilized to provide prices for a number of completion contracts that are offered to users, based upon requests for cloud services.

At 546, the method 540 can include offering, by the cloud service manager, to a first user among the plurality of users, a cloud service menu including a number of completion contracts for a request for cloud services, wherein the completion contracts are continuous-decision based and have different prices and different durations to complete the request for cloud services.

As discussed herein, the completion contracts are continuous-decision, indicating that prices of the completion contract are determined utilizing fractional nodes. Additionally, completion contracts are determined with the constraints discussed herein. For example, the different prices of the of completion contracts are determined with a constraint that demand for nodes within a period, less lessor nodes, does not exceed a current capacity within that interval.

At 548, the method 540 can include allocating, by the cloud service manager, a set of cloud resources to complete the request for cloud services in response to one of the number of completion contracts being accepting by the first user.

The method 540 may further include acquiring (e.g., renting), by the cloud service manager, a number of lessor cloud resources based upon a plurality of accepted completion contracts. As discussed herein, fulfillment of a completion contract may utilize lessor cloud resources.

Method 540 may be performed iteratively. For instance, a plurality of requests may be received by a cloud service manager continuously. As these requests are received, subsequent completion contracts may be determined dynamically. These subsequent completion contracts can take into consideration information (e.g., a price to rent a lessor node, etc.) gathered subsequently to a previously offered completion contract. This information can be continuously and/or dynamically updated, as the method 540 continues to be performed.

In the present disclosure, reference is made to the accompanying drawings that form a part hereof, and in which is shown by way of illustration how a number of examples of the disclosure can be practiced. These examples are described in sufficient detail to enable those of ordinary skill in the art to practice the examples of this disclosure, and it is to be understood that other examples can be used and that process, electrical, and/or structural changes can be made without departing from the scope of the present disclosure.

The figures herein follow a numbering convention in which the first digit corresponds to the drawing figure number and the remaining digits identify an element or component in the drawing. Elements shown in the various figures herein can be added, exchanged, and/or eliminated so as to provide a number of additional examples of the present disclosure. In addition, the proportion and the relative scale of the elements provided in the figures are intended to illustrate the examples of the present disclosure, and should not be taken in a limiting sense. As used herein, the designators “N”, and “P”, particularly with respect to reference numerals in the drawings, indicate that a number of the particular feature and/or component so designated can be included with a number of examples of the present disclosure. The designators “N” and “P” can refer to a same feature and/or component, or different features and/or components.

As used herein, “logic” is an alternative or additional processing resource to perform a particular action and/or function, etc., described herein, which includes hardware, e.g., various forms of transistor logic, application specific integrated circuits (ASICs), etc., as opposed to computer executable instructions, e.g., software firmware, etc., stored in memory and executable by a processor. Further, as used herein, “a” or “a number of” something can refer to one or more such things. For example, “a number of widgets” can refer to one or more widgets. Also, as used herein, “a plurality of” something can refer to more than one of such things.

The above specification, examples and data provide a description of the method and applications, and use of the system and method of the present disclosure. Since many examples can be made without departing from the spirit and scope of the system and method of the present disclosure, this specification merely sets forth some of the many possible embodiment configurations and implementations.

What is claimed:

1. A system, comprising:
a request engine to continuously receiving requests for cloud services from a plurality of users of a cloud system;
a menu engine to generate cloud service menu to be offered to a number of the plurality of users, the cloud service menu including a number of completion contracts for a request for cloud services, wherein the completion contracts are continuous-decision based and have different prices and different durations to complete the request for cloud services; and
a resource allocation engine to allocate a number of cloud resources to complete the request for cloud services in response to a user selection of one of the number of completion contracts.

2. The system of claim 1, wherein the number of completion contracts include a first completion contract having a first price and a first completion duration, and a second completion contract having a second price and a second completion duration, wherein the first price is greater than the second price and the first completion duration less than the second completion duration.

3. The system of claim 1, further comprising the resource allocation engine to allocate the number of cloud resources, wherein a first portion of the number of cloud resources are managed by a first organization and a second portion of the number of cloud resources are managed by a second organization.

4. The system of claim 3, wherein the resource allocation engine allocates a first number of nodes to perform a first cloud service for a current period with a first completion duration prior to allocating a second number of nodes to perform a second cloud service for the current period with a second completion duration.

5. The system of claim 4, wherein the first completion duration is less than the second completion duration.

6. The system of claim 1, further comprising an output engine to determine a plurality of variables using a plurality of parameters received, wherein the plurality of variables includes per-period-period prices for each duration in each period and an expected number of outsourced node-periods to be acquired for each duration in each period.

7. The system of claim 1, further comprising a benchmark engine to generate a benchmark completion duration for the request for cloud services.

8. A non-transitory machine-readable medium storing instructions executable by a processing resource to cause a computing system to:
continuously receive from a plurality of users of a cloud system, a plurality of cloud service requests;
provide a cloud service menu to the plurality of users for completion of the plurality of cloud service requests, the cloud service menu including a number of completion contracts for a request for cloud services, wherein the completion contracts are continuous-decision based and have different prices and different durations to complete the request for cloud services; and
allocate cloud resources to fulfill a user-selected completion contract from the cloud menu, wherein the allocated cloud resources are selected from local cloud resources and lessor cloud resources.

9. The medium of claim 8, including instructions executable to receive periodic use rates for the lessor cloud resources.

10. The medium of claim 9, wherein the lessor cloud resources are from a first lessor and a second lessor.

11. The medium of claim 8, wherein for a particular period, an additional completion contract corresponding to a job submitted at a particular duration has an offered price equal to a product of the job size and a per-node-price allocated for the particular duration.

12. A method, comprising:
continuously receiving, by a cloud service manager, a plurality of cloud service requests from a plurality of users in a cloud system;
determining by the cloud service manager, a per-resource price for a lessor cloud resource;
offering, by the cloud service manager, to a first user among the plurality of users, a cloud service menu including a number of completion contracts for a request for cloud services, wherein the completion contracts are continuous-decision based and have different prices and different durations to complete the request for cloud services; and
allocating, by the cloud service manager, a set of cloud resources to complete the request for cloud services in response to one of the number of completion contracts being accepting by the first user.

13. The method of claim 12, further comprising:
acquiring, by the cloud service manager, a number of lessor cloud resources based upon a plurality of accepted completion contracts.

14. The method of claim 12, wherein the different prices of the number completion contracts are determined with fractional nodes.

15. The method of claim 12, wherein the different prices of the number of completion contracts are determined with a constraint that expected demand for nodes within a period, less lessor nodes, does not exceed a current capacity within that interval.
